(19) United States
(12) Patent Application Publication
(10) Pub. No.: US 2014/0261405 A1
(43) Pub. Date: Sep. 18, 2014

(54) FACEPIECE WITH NOISE REDUCTION FOR COMMUNICATION

(71) Applicants: Marco Tekelenburg, Zelienople, PA (US); Michael F. Becker, Wexford, PA (US); Kaustubh Misra, Allison Park, PA (US); Christopher L. Prete, Cranberry Township, PA (US); Robert Kilgore, Pittsburgh, PA (US); Gregory G. Imblum, Monroeville, PA (US); Viktor Gotz, Wexford, PA (US)

(72) Inventors: Marco Tekelenburg, Zelienople, PA (US); Michael F. Becker, Wexford, PA (US); Kaustubh Misra, Allison Park, PA (US); Christopher L. Prete, Cranberry Township, PA (US); Robert Kilgore, Pittsburgh, PA (US); Gregory G. Imblum, Monroeville, PA (US); Viktor Gotz, Wexford, PA (US)

(21) Appl. No.: 13/796,886

(22) Filed: Mar. 12, 2013

(51) Int. Cl. A62B 9/00; A62B 9/02; A62B 7/00; A62B 18/08; A62B 18/02

(52) U.S. Cl. CPC A62B 9/006; A62B 18/08; A62B 18/02; A62B 7/00; A62B 9/02
USPC 128/201.19

(57) ABSTRACT

A respirator system includes a facepiece, a communication system and a control system in operative connection with the communication system. The control system is adapted to control voice transmittal via the communication system based at least in part upon measurement of a variable other than sound. The variable is related to speech of a user of the facepiece. The variable may, for example, be related to respiration of the user.

### BACKGROUND

The following information is provided to assist the reader in understanding the devices, systems and/or methods disclosed below and the environment in which such devices, systems and/or methods will typically be used. The terms used herein are not intended to be limited to any particular narrow interpretation unless clearly stated otherwise in this document. References set forth herein may facilitate understanding of the devices, systems and/or methods or the background. The disclosures of all references cited herein are incorporated by reference.

A facepiece or face mask (also sometimes referred to as a respirator mask or a mask), which is, for example, sealed to the face of the user, is used in many different types of systems to protect a user from potentially hazardous elements in an environment. The facepiece typically includes a lens through which the user can view the surrounding environment. The facepiece may also include a port or mount for fluid connection with, for example, a filter system or a second-stage pressure regulator through which inspired air passes into the face mask and an exhalation port through with expired air passes out of the mask.

A facepiece may, for example, be used in connection with a supplied-air respirator such as a self-contained breathing apparatus (SCBA), which permits a person to breathe in hazardous environments such as fires and confined spaces where breathing would be difficult or impossible without mechanical aid. A supplied-air respirator may, for example, include a harness and carrier assembly, an air cylinder full of high pressure compressed air for breathing and at least one, and more typically two, air-pressure regulators. A first or first-stage regulator is typically mounted near the air cylinder and functions to reduce the relatively high pressure of the compressed air from the air cylinder to above atmospheric pressure. The air cylinder typically contains air or gas under high pressure (for example, 2200 psi to 4500 psi). The first-stage regulator may, for example, reduce the pressure to about 80-100 psi. A second or second-stage regulator is typically mounted on a facepiece and functions to adjust the flow of air to meet the respiratory needs of the user. Respiration-controlled regulator assemblies are disclosed, for example, in U.S. Pat. Nos. 4,821,767 and 5,016,627.

In the case of an SCBA, the user's respiration controls a valve system (for example, including an inhalation valve and an exhalation valve) to control delivery of pressurized air via the second-stage regulator. Often, it is desirable to maintain a slight positive pressure within the facepiece relative to ambient pressure. Facepieces for supplied-air respirators in which a positive pressure is maintained within the facepiece are often referred to as pressure demand facepieces, while other facepieces for supplied-air respirators are often referred to as demand facepieces.

A number of facepieces or respiration systems include a microphone to assist in communication by the users to others. Continuously-on communication systems, used in most SCBA voice amplification systems, include a microphone that is continuously activated. The microphone detects both wanted and unwanted noise. The unwanted noise includes, for example, respirator airflow noise and user inhalation noise.

A number of methods and/or systems have been incorporated into a number of facepiece or respiration (respirator) systems to reduce unwanted noise. For example, voice activation communication systems have been used in an attempt to reduce unwanted noise. Such voice activation communication systems sense the presence and absence of sound to respectively activate and deactivate a microphone. However, during inhalation, the presence of respiratory noise can activate the microphone and accordingly unwanted noise is communicated. Although, it is possible to use electronic filters to detect and cancel respiratory noise, such filtering often adversely affects speech communications quality. In that regard, filtering is likely to cancel and/or clip components of speech. Furthermore, voice activation systems often exhibit a delayed response when speech is initiated, resulting in clipping of some speech components.

Push-to-talk communication systems require a user to manually activate a remote switch (for example, a push button in chest console, a finger switch, etc.) remote from the microphone to activate the communications system. A push-to-talk system can exclude unwanted noise, but communications can occur only when the user activates a remote switch. To activate the remote switch, the user must locate the switch and either continuously depress it or depress it multiple times to activate and then deactivate the system. In many respirator applications, it is difficult to locate, access, and/or operate remote switches. Respirator users often have gloved hands and limited visibility that may impede the operation of remote switches.

### SUMMARY

In one aspect, a respirator system includes a facepiece, a communication system including a voice transmission system, and a control system in operative connection with the voice transmission system. The control system controls voice transmittal via the voice transmission system based at least in part upon measurement of a variable other than sound. The variable other than sound is related to speech of a user of the facepiece. The variable other than sound may, for example, be related to respiration of the user. The control system may, for example, control the voice transmission system at least in part on the basis of a stage of respiration.

In a number of embodiments, the voice transmission system includes a microphone. The control system may, for example, control output from the voice transmission system at least during inhalation to decrease noise associated with inhalation. The control system may, for example, include a sensor system to detect a stage of respiration of the user. In a number of embodiments, the sensor system comprises a pressure sensor, a proximity sensor, a motion sensor, a position sensor, a flow sensor, a temperature sensor or a gas sensor. As used herein, the term “position sensor” refers to any device that provides or enables position measurement (either absolute or relative). Such position sensors may, for example, be linear, angular or multi-axis.

The system may, for example, further include a regulator, and the facepiece may, for example, include an interface to which the regulator is removably attachable. The regulator may, for example, include the sensor system to detect the stage of respiration of the user. The regulator may, for example, include a housing. The sensor system may, for example, include a pressure sensor, a proximity sensor a position sensor, a motion sensor, a flow sensor, a temperature sensor or a gas sensor within the housing.

In a number of embodiments, the regulator includes a valve assembly including an inlet for connection to a source of breathing gas, an outlet for connection to the facepiece to provide breathing gas to a user, an actuating mechanism for controlling flow of breathing gas between the inlet and the outlet and a flexible elastomeric diaphragm in operative connection with the actuating mechanism. The diaphragm is in fluid connection with ambient environment on a first side thereof and is in fluid connection with an interior of the facepiece on a second side thereof. The sensor system may, for example, include a proximity sensor, a position sensor or a motion sensor in operative connection with a moving component of the actuating mechanism or the diaphragm of the regulator or a pressure sensor or a flow sensor in fluid connection with a volume of the regulator on the second side of the diaphragm. The microphone may, for example, be attached to the regulator.

In another aspect, a pressure regulator for use in connection with a facepiece includes a valve assembly including an inlet for connection to a source of breathing gas, an outlet for connection to the facepiece to provide breathing gas to a user, an actuating mechanism for controlling flow of breathing gas between the inlet and the outlet, and a flexible elastomeric diaphragm in operative connection with the actuating mechanism. The diaphragm is in fluid connection with ambient environment on a first side thereof and in fluid connection with an interior of the facepiece on a second side thereof. The pressure regulator further includes a sensor system adapted to be placed in operative connection with a communication system comprising a voice transmission system. The sensor system provides a signal to control the voice transmission system based at least in part upon measurement of a variable other than sound. The variable other than sound is related to speech of a user of the facepiece. The variable other than sound may, for example, be related to respiration of the user.

The sensor system may, for example, provide a signal to control the voice transmission system at least in part on the basis of a stage or respiration. In a number of embodiments, the voice transmission system includes a microphone. The microphone may, for example, be attached to the regulator. The control system may, for example, control output from the voice transmission system during at least inhalation to decrease noise associated with inhalation.

In a number of embodiments, the sensor system detects at least inhalation by the user. The sensor system may, for example, include a proximity sensor, a position sensor or a motion sensor in operative connection with a moving component of the actuating mechanism or the diaphragm of the regulator or a pressure sensor or a flow sensor in fluid connection with a volume of the regulator on the second side of the diaphragm.

In a further aspect, a facepiece system for use in a respiration system includes a facepiece and a pressure regulator in fluid connection with the facepiece. The pressure regulator includes a valve assembly including an inlet for connection to a source of breathing gas, an outlet for connection to the facepiece to provide breathing gas to a user, an actuating mechanism for controlling flow of breathing gas between the inlet and the outlet and a flexible elastomeric diaphragm in operative connection with the actuating mechanism. The diaphragm is in fluid connection with ambient environment on a first side thereof and in fluid connection with an interior of the facepiece on a second side thereof. The facepiece system further includes a sensor system adapted to be placed in operative connection with a voice transmission system of a communication system. The sensor system provides a signal to control the voice transmission system based at least in part upon measurement of a variable other than sound, which is related to speech of a user of the facepiece.

In still a further aspect, a method of controlling voice transmission of a user of a respiration system includes controlling voice transmission based at least in part upon measurement of a variable other than sound, which is related to speech of a user of the facepiece. The variable other than sound may, for example, be related to respiration of the user, and controlling voice transmission may, for example, include controlling output from a voice transmission system at least in part on the basis of a stage of respiration of the user.

The devices, systems and/or methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a side view of an embodiment of a facepiece with a second-stage pressure regulator attached thereto.

FIG. 2A illustrates a side cross-sectional view of the second-stage regulator of FIG. 1.

FIG. 2B illustrates a perspective view of the second-stage regulator of FIG. 1.

FIG. 2C illustrates another cross-section view of the second-stage regulator of FIG. 1.

FIG. 3 illustrates a side, cross-sectional view of the facepiece and attached second-stage pressure regulator of FIG. 1.

FIG. 4 illustrates an enlarged side, cross-sectional view of the facepiece FIG. 1 with the pressure regulator removed therefrom.

FIG. 5 illustrates another embodiment of a facepiece with a pressure regulator attached thereto.

FIG. 6 illustrates a schematic representation of a system (for example, a respiration system or a mask system) including a respiration actuated control system in communicative connection with a voice transmission device system, which may, for example, include a microphone.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a sensor” includes a plurality of such sensors and equivalents thereof known to those skilled in the art, and so forth, and reference to “the sensor” is a reference to one or more such sensors and equivalents thereof known to those skilled in the art, and so forth.

In several representative embodiments, devices, systems and methods hereof are described in connection with a facepiece or face mask for use in a pressure demand or demand supplied air respirator such as an SCBA as described above. However, the devices, systems and methods hereof may be used in connection with any facepiece or face mask in which user respiration can interfere with voice transmission. Additional respirator applications in which user respiration can interfere with voice transmission include, but are not limited to, demand airline respirators, pressure demand airline respirators, constant flow airline respirators, constant flow SCBA, air purifying respirators, powered air purifying respirators, and breath responsive powered air purifying respirators.

FIG. 1 illustrates a representative embodiment of a full facepiece or respirator face mask 10 that forms part of a respiration system 5. As used herein, a respiration system refers to any system used to provide breathing gas to a user from a source of breathing gas. As illustrated in FIG. 1, facepiece 10 may, for example, include a face blank 20 (fabricated, for example, from a silicon rubber) that includes a rear opening 30 which seals around the face of a user. Face blank 20 is sealingly attached to a forward section 15 (see, for example, FIG. 1) of facepiece 10, which includes lens 50 on an upper section thereof and respiration and/or filtering components formed in a lower section thereof. Face blank 20 may, for example, be sealingly attached to the forward section of facepiece 10 via a peripheral rim or edge.

As used herein in reference to facepiece 10 and other components, terms such as “front”, “forward”, “rear”, rearward”, “up”, “down” or like terms refer generally to reference directions associated with a person wearing facepiece 10 and standing upright.

Facepiece 10 may, for example, have attached thereto an attachment section (not shown) which may be connected to, for example, strapping to attach facepiece 10 to the head of the user and to maintain face blank 20 of facepiece 10 in sealing engagement with the face of the user as known in the art.

Lens 50, through which the user views the surrounding environment, is attached to an upper portion of the front section 15 of facepiece 10 via a sealing rim 70. Respiration and/or filtering components are attached to front section 15 of facepiece 10 below lens 50. As illustrated, for example, in FIG. 1, facepiece 10 includes a generally central port or opening. The port is formed in the forward end of an extending wall section 120 that extends forward from the remainder of the lower portion of front section 15.

A respirator component structure of housing 200 is attached to forward extending wall section 120. In that regard, housing 200 forms a sealed engagement, fit or connection with the internal wall of extending section 120. Housing, 200 may, for example, include a channel, groove or other connector element 210 around the periphery thereof which forms a sealing engagement with the internal wall of extending section 120. Housing 200 may be of generally any shape to sealingly seat in a port of virtually any cooperating shape.

Housing 200 also includes an exhalation port 220 (see, for example, FIG. 3) over which sealing valve member 230 (for example, an umbrella valve member as known in the art; see, for example, FIG. 4) is connected. In the illustrated embodiment, valve member 230 is biased in a closed position via, for example, a spring 240 (see, for example, FIG. 4). Spring 240 is retained in connection with valve member 230 by a retainer 242. Biasing of valve member 230 results in a positive pressure within facepiece 10 as known in the art for operation in a pressure demand mode. Facepiece 10 may also be operated in a demand mode in which valve member 230 is not biased in a closed position. Valve 230 opens upon exhalation by a user of facepiece 10 but closes upon inspiration to prevent inspired air from passing through exhalation port 220.

An interface port 252 is formed in an interface portion or interface 250 of component housing 200 of facepiece 10 to place facepiece 10 in fluid connection with, for example, a second-stage pressure regulator 400 or other regulator so that pressurized breathing gas (air or oxygen) may be supplied from a pressurized air tank 500 (see FIGS. 1 and 2A).

When connected to facepiece 10, pressure regulator 400 delivers breathing gas to the user on demand. As known in the art, pressure regulator 400 may, for example, include a diaphragm or diaphragm assembly 402 biased by a spring 404 that divides the regulator assembly into an inner chamber 406 in fluid connection with an interior of facepiece 10 and an outer chamber 408 in fluid connection with the surrounding ambient environment (see FIG. 2A). Diaphragm 402 is coupled to an actuating mechanism 410 which opens and closes an inlet valve 412. The user's respiration creates a pressure differential between inner chamber 406 and outer chamber 408 of the regulator assembly 400 which, in turn, causes displacement of diaphragm 402 thereby controlling (that is, opening and closing) inlet valve 412 via mechanism 410. As a result, regulators such as regulator 400 are often called pressure demand regulators. An example of a pressure regulator operating in a similar manner to that described above is the FIREHAWK® regulator available from Mine Safety Appliances Company of Pittsburgh, Pa.

As illustrated in FIG. 2A, an inlet 414 of regulator 400 may, for example, be connected to pressurized air tank 500 via a flexible hose 510 and a first stage pressure regulator 520. Inlet 414 may, for example, be a barbed inlet connector as known in the art for secure connection to hose 510. An outlet 416 is in fluid connection with valve 412. A flow adjustment mechanism 418 may, for example, be placed in connection with outlet 416 as known in the art.

Spring-loaded retaining flanges 420 (see FIG. 2B) of pressure regulator 400 form a releasable connection with cooperating mounting flanges 256 of mounting interfaces 254 on the perimeter of interface port 252. Pressure regulator 400 includes release buttons 430 on each side thereof which may be depressed to release pressure regulator from connection with regulator port 252.

An inhalation port 260 is in fluid connection with interface port 252 and provides a port for entry of, for example, pressurized air from pressure regulator 400 into the interior of facepiece 10. In that regard, inhalation port 260 is in fluid connection with an inhalation check valve 264 including, for example, a valve seating 266 and a flexible flap valve 268. Inhalation valve 264 opens upon inhalation by a user of facepiece 10 but closes upon expiration to prevent expired air from passing through inhalation port 260. Contamination of pressure regulator 400 via inhalation port 260 during exhalation is thereby prevented.

In a number of embodiments, respirator mask 10 may, for example, also include a nose cup 300 that assists in directing the flow of air within respirator mask 10 (see FIG. 13). Nose cup 300, which encompasses the nose and chin portion of the face, may, for example, be formed integrally from an elastomeric polymeric material such as an elastomer (for example, silicone). In the illustrated embodiment, nose cup 300 is attached to component housing 200 from the rear by, for example, extending or stretching a forward port or opening 310 of nose cup 300 around a flange 270 which is attached to component housing 200 via threading 272 on flange 270 and cooperating threading 282 on a rearward element 280 of component housing 200. Nosecup 300 may, for example, include one or more inhalation check valves 320. In the illustrated embodiment, a speech voicemitter 284 is positioned between port 310 and rearward element 282 to help provide intelligible speech transmittance through facepiece 10. In several embodiments, voicemitter 284 was formed from a thin film enclosed in a perforated aluminum housing. Passages such as passages 216 may, for example, be formed in housing 200 to facilitate voice transmittal.

Component housing 200 may, for example, be injection molded from a polymeric material such as, for example, a polycarbonate, a polyester or a polycarbonate/polyester blend. Likewise, lens 50 may, for example, be injection molded from a polymeric material (for example, a transparent polycarbonate).

Respirator system 5 includes an electronic voice communications system that provides, for example, voice amplification, transmission and/or radio communications functionality. For example, respirator system 5 may include a voice transmittal system including a sound sensor or microphone that is suitably configured and positioned to detect the sound of user speech (see, for example, FIG. 6). As used herein, the term “microphone” refers to an acoustic-to-electric transducer or sensor that converts sound into an electrical signal. The electrical signal may, for example, be transmitted to an amplifier and/or speaker for communication by the user with others in the vicinity of the user and/or transmitted for communication by the user to others remote from the user. In the embodiment illustrated in FIGS. 1 through 4, pressure regulator 400 includes or has connected thereto in the vicinity of a section or surface 456 (which is generally adjacent to ambient port 298 upon connection of pressure regulator 400 to interface 250) a microphone 470 as a component of a voice transmission system for transmission of the user's voice. Such positioning of microphone 470 provides a generally direct path between the user's mouth and microphone 470. Sealing member 462 provides a seal between microphone 470 and the ambient atmospheres. Pressure regulator 400 and sealing member 462 thereof protect microphone 470 from environmental elements such as dirt and water that can damage microphone 470.

As described above, a number of respiration systems include voice activation communication systems including a sensor system in which the presence and absence of sound is sensed to respectively activate and deactivate a microphone. However, a number of significant problems are associated with such voice-activated systems. In a number of embodiments hereof, respirator mask 10 further includes or is in operative connection with a control system 600 in communicative connection with microphone 470 (and/or other component of the voice transmission system), which may be positioned on pressure regulator 400, within facepiece or mask 10 or elsewhere) to control the voice transmission system (for example, to control microphone 470 and/or another component of the voice transmission system). Control system 600 includes a sensor system 604 to sense or measure a variable, other than sound, which is associated with speech. Control system 600 controls the voice transmission system at least in part on the basis of the measured variable to decrease or eliminate respiration noise.

In a number of embodiments, a variable (other than sound) associated with the user's respiration is sensed and the voice transmission system is controlled as a function of the user's respiration (for example, as a function of a stage or phase of the user's respiration). Control system 600 may, for example, include an actuator or switch that is responsive to user respiration to control microphone 470 and/or other electronic communication system(s)/device(s) of the voice transmission system. In that regard, control system 600 may be operative to disable (or place in an off state) microphone 470 when the user is inhaling, thereby excluding or canceling unwanted inhalation noise from the respirator and from the user. In general, speech does not occur during inhalation. Control system 600 may further be operative to enable (or place in an on state) microphone 470 when the user is exhaling, thereby enabling transmission of intended voice communications. However, switching microphone 470 between and on state and an off state may itself introduce noise. In a number of embodiments, the signal from microphone 470 may, for example, be controlled in a manner to control the output of the voice transmission system to reduce or eliminate noise associated with respiration. For example, gain or amplification may be maintained relatively higher during expiration and relatively lower during inhalation. Changing gain and/or another variable in a more gradual manner than associated with an on/off switching may reduce noise associated with on/off switching (for example, “clicking”). In other embodiments, the signal from microphone 470 may, for example, be controlled in a manner to control how the microphone signal is processed. For example, during inhalation, the control system selects microphone signal processing parameters that are optimized to identify and minimize respirator inhalation noise and user inhalation noise. During exhalation, the control system selects microphone signal processing parameters that are optimized to maximize voice transmission clarity.

There are many ways to control, process or manipulate the microphone (sound sensor) and/or microphone signal based on respiration. As described above, one may modify the microphone signal gain level based on the stage of respiration. In a representative embodiment, the microphone signal is a digital signal that is routed to an audio codec with integrated audio processor. The codec with integrated processor is used to manipulate the digital audio signal and convert the digital signal to an analog signal. The codec with integrated processor may, for example, include equalization, filtering, and Digital Signal Processing (DSP) capabilities. The codec with integrated processor applies gain settings to the audio signal. The gain setting is varied dependent on the stage of respiration. When the respirator user stops inhaling, the microphone signal gain level may, for example, be set at a level that produces an optimized voice transmission sound pressure level. When the user starts to inhale, the microphone signal gain level may, for example, be ramped down to a reduced level to limit the transmission/amplification of noise during inhalation. As the respirator user stops inhaling, the microphone signal gain level may be ramped up to the increased level to restore the optimal voice transmission sound pressure level. The microphone signal gain level is ramped down and up (that is, changed gradually) to minimize abrupt sound pressure level changes including “popping” and “clicking” noises.

In addition to using the sensor to adjust the microphone signal gain level (whether switching or ramping the gain level), it is also possible to use the sensor to vary other audio signal parameters. For example, the sensor may be used to vary equalization, filtering, and DSP algorithm settings dependent on the state of respiration. For example, filters and DSP algorithms may be used to minimize respiratory noise. Respiratory noise, specifically inhalation noise, can include significant high frequency content. Human speech also contains high frequency content. As an example, the pronunciation of some English language consonants/sounds, including “f” and “s”, includes high frequency content. As such, there is a risk that the respiratory filters and DSP algorithms may negatively affect voice transmission. The use of a respiration state sensor in combination with filters and DSP algorithms may, however, improve voice transmission quality. For example, when the sensor detects an inhalation state, the filter and DSP settings may be set to aggressively limit inhalation noise. When the sensor detects an exhalation state, the filter and DSP settings may be set to optimally detect and transmit the voice signal.

Control system 600 may, for example, include a system or sensor that is responsive (either directly or indirectly) to pressure changes, flow changes and/or other variables associated with a stage of the user's respiration (for example, inhalation or exhalation). As described above, pressure regulator 400 includes a diaphragm or diaphragm assembly 402 that moves rearward or inward during inhalation and moves forward or outward following inhalation and remains outward during exhalation. In that regard, the user's respiration creates a pressure differential between inner chamber 406 and outer chamber 408 of the regulator assembly 400, causing displacement of diaphragm 402 and, thus, displacement of coupled linkage or mechanism 410 to open valve or valve mechanism 412 during inhalation and close valve 412 following inhalation. Valve 412 remains closed during exhalation. In a number of embodiments, control system 600 includes a sensor system (including, for example, a sensor or a switch) which is sensitive to movement or position of, for example, the diaphragm or diaphragm assembly 402.

As, for example, illustrated in FIG. 2C, in a number of embodiments, one or more magnets 610 are positioned on a respiration-actuated, moveable component of pressure regulator 400 (for example, upon a component of diaphragm 400 or mechanism 410). An electronic switch 620 that is responsive to a magnetic field (for example, a Hall effect switch or a reed switch) may, for example, be positioned on a fixed portion of pressure regulator 400. Alternatively, a magnet 610 may be positioned on a fixed portion of pressure regulator 400, and switch 620 may be positioned on a respiration-actuated moveable component of pressure regulator 400. Switch 620 may, for example, open and close in response to the position of the magnetic field as determined by the movement of the moveable component. Switch 620 is in operative communication (for example, wired or wireless communication) with electronics 630 (for example, one or more components of a printed circuit board) and thereby with microphone 470 and/or other components of the voice transmission system to control the voice transmission system as a function of a stage or respiration of the user. As the user of respiration facepiece or mask 10 of respiration system 5 inhales, magnet 610 (or switch 620) travels in one direction relative to fixed switch 620 (or fixed magnet 610) to provide an indication that the user's stage or respiration is inhalation. In a number of embodiments, microphone 470 may, for example, be deactivated or switched off during inhalation so that the electronic voice communications system does not transmit airflow noise from pressure regulator 400 and inhalation noise produced by the user. As the user stops inhaling and subsequently exhales, magnet 610 (or switch 620) travels in an opposite direction relative to fixed switch 620 (or fixed magnet 610) to activate microphone 470. Once again, most people speak only when exhaling or can readily alter their speech patterns to speak only when exhaling. Accordingly, microphone 470 is activated only when speech is likely to occur. As described above, switch 610 may alternatively be used to as an indication of the stage of respiration to control other components of the voice transmission system to, for example, control gain.

A respirator system may additionally or alternatively include a respiration-actuated control system in operative connection with a voice transmission system wherein the control system includes a pressure sensor in fluid communication with the internal volume of air within the respirator system. A pressure sensor may, for example, be placed in fluid connection with a respirator system such as system 5 at any point in the flow path between the pressurized tank 500 and the user. The pressure sensor may, for example, measure facepiece pressure changes associated with the stage or respiration. Additionally or alternatively, the pressure sensor may, for example, measure first-stage regulator outlet pressure changes associated with a stage of respiration. During respiration, the pressure sensor may, for example, control the microphone signal. Similarly, the respirator system may additionally or alternatively include a respiration-actuated control system in operative connection with a voice transmission system wherein the control system includes a flow sensor in fluid communication with the respirator system. A flow sensor may, for example, be placed in fluid connection with a respirator system such as system 5 at any point in the flow path between the pressurized tank 500 and the respirator exhalation port 220.

As discussed above, one or more sensors may be used at one or more places in the respirator circuit to detect respiration, and thereby control the voice transmission system. As also described above, the first-stage regulator reduces cylinder pressure (high pressure) to a pressure that is suitable for the second-stage regulator (medium pressure). During respiration, the medium pressure will momentarily decrease during inhalation. Accordingly, a pressure sensor may be located on or downstream of the first-stage regulator to detect medium pressure changes in accordance with user respiration. Likewise, one or more flow sensors may be placed between the first-stage regulator and second-stage regulator. The first-stage regulator supplies air to the second-stage regulator. During inhalation and exhalation states, the flow rate from the first-stage regulator varies from zero to an increased flow rate. Accordingly, a flow rate sensor between the first-stage regulator and the second-stage regulator may be used to detect user respiration. One or more flow sensors may also be placed between the air cylinder and the first-stage regulator. The cylinder supplies air to the first-stage regulator. During inhalation states, the flow rate from the cylinder varies from zero to an increased flow rate. Accordingly, a flow sensor may be placed downstream of the cylinder (that is, at or downstream of the cylinder valve) to detect user respiration.

FIG. 5 illustrates an embodiment of a facepiece or respirator mask 10a including an internal volume defined, in part, by lens 50a as described in connection with respirator mask 10a. As also described in connection with facepiece 10, facepiece 10a includes an interface 250a for attachment of a pressure regulator 400a thereto. Facepiece 10a further includes a microphone 470a positioned to receive sound from the user's voice. In the illustrated embodiment, a control system 600a includes a pressure sensor 610a in fluid connection with the internal volume of facepiece 10a and in electronic communication with microphone 470a.

In the illustrated embodiment, pressure sensor 610a is illustrated to be within the interior volume of facepiece 10a, but it may be placed at any suitable position to be in fluid communication with the pressure within facepiece 10a. Pressure sensor 610a may, for example, be placed within volume/pressure regulator 400a to be in fluid communication with the interior of facepiece 10a.

As described above in connection with microphone 470, microphone 470a may, for example, be deactivated or placed in an off state when air pressure decreases below a predetermined value. Microphone 470a may be activated or placed in an on when air pressure increases above a predetermined value. In that regard, as the user of facepiece 10a inhales, facepiece pressure decreases and microphone 470a is deactivated. When microphone 470a is deactivated, the electronic voice communications system including microphone 470a does not transmit airflow noise from pressure regulator 400a and does not transmit noise resulting from inhalation by the user. As the user of facepiece 10a stops inhaling and subsequently exhales, facepiece pressure increases and microphone 470a is activated. As also described above, a pressure sensor and/or a flow sensor may alternatively be used to as an indication of the stage of respiration to control other components of the voice transmission system to, for example, control gain and/or control microphone signal processing parameters.

Other variables associated or related directly to speech or to a variable/state associated with speech (for example, to a stage of respiration) that may be measured to control microphone 470 and/or other components of the voice transmission system include, but are not limited to, flow, temperature and/or the concentration of various gases. For example, levels of carbon dioxide may be measured.

FIG. 6 illustrates a schematic illustration of a system hereof including an electronic voice communication system that may, for example, include a sound sensor/microphone and/or other components of a voice transmission device or system as described above and a control system in operative connection with the voice transmission system. As described above, the control system controls the operation of the voice transmission system in response to or as a function of the output of a sensor for the measurement of a variable other than sound that is related to the user's speech. For example, the variable that is measured may be related to (for example, indicative of the stage of) the user's respiration. A state or stage of the user's respiration and/or other variables associated with speech may be measured using one or more measuring or sensor systems including, for example, pressure sensors, proximity sensors, motions sensors, position sensors, flow sensors, gas sensors etc.

As described above, most commercially available SCBA and other respiration systems which include a voice amplification or transmission systems include a microphone that is continuously activated and amplified at a constant gain. Such systems are sometimes referred to as continuously-on communication systems. In a continuously-on communication system, the microphone detects both wanted and unwanted noise. Unwanted noise includes respirator airflow noise and user inhalation noise. The inclusion of unwanted noise significantly diminishes the quality of electronic communications. The devices, systems and methods hereof exclude a substantial amount of unwanted noise to improve the quality of the electronic communications as compared to continuously-on communication systems. The devices, systems and methods hereof may, for example, provide for a decrease in power consumption as compared to continuously-on communication systems. In that regard, continuously-on communication systems continuously draw power to detect and process communications. In a number of embodiment of devices, systems and methods hereof, voice communications are processed differently during different stages of respiration (for example, inhalation versus exhalation), thereby decreasing noise and, in a number of embodiments, power consumption.

As described above, control of a microphone and/or other component(s) of a voice transmission system as a function of respiration/stage or respiration in the present devices, system and/or methods, eliminates at least a majority of unwanted noise. However, the devices, systems and/or methods hereof immediately detect speech as it is initiated, and thereby reduce speech canceling, clipping and/or delaying as compared to many voice-activated systems.

Respiration systems or respirators can also include a push-to-talk or manual activation communications system, which require a user to manually activate a remote switch (for example, a push button in a chest console, finger switch, etc.) to activate the communications system to transmit voice communications. A push-to-talk system can successfully exclude much unwanted noise. However, communications can occur only when the user manually activates a remote switch. To activate the remote switch, the user must locate the switch and either continuously depress it or depress it multiple times to activate and then deactivate the system. In many respirator applications, it is difficult to locate, access, and/or operate remote switches. Gloved hands and limited visibility may, for example, impede the operation of remote switches. Because the devices, systems and methods hereof automatically control the voice transmission system to, for example, optimize voice transmission when speech is likely to occur, it is not necessary for the respirator user to locate and operate a remote switch, thereby simplifying and improving the use of the communications system as compared to push-to-talk system. Furthermore, product cost is decreased when compared to systems that require remote switching modules and/or devices.

The foregoing description and accompanying drawings set forth embodiments. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A respirator system, comprising:
a facepiece;
a communication system comprising a voice transmission system; and
a control system in operative connection with the voice transmission system, the control system controls voice transmittal via the voice transmission system based at least in part upon measurement of a variable other than sound, the variable other than sound being related to speech of a user of the facepiece.

2. The respiration system of claim 1 wherein the variable other than sound is related to respiration of the user.

3. The system of claim 2 wherein the control system controls the voice transmission system at least in part on the basis of a stage of respiration.

4. The system of claim 3 wherein the voice transmission system comprises a microphone, and the control system controls output from the voice transmission system at least during inhalation to decrease noise associated with inhalation.

5. The system of claim 4 wherein the control system comprises a sensor system to detect a stage of respiration of the user.

6. The system of claim 5 wherein the sensor system comprises a pressure sensor, a proximity sensor, a motion sensor, a position sensor, a flow sensor, a temperature sensor or a gas sensor.

7. The system of claim 4 further comprising a regulator, wherein the facepiece comprises an interface to which the regulator is removably attachable, the regulator comprising the sensor system to detect the stage of respiration of the user.

8. The system of claim 7 wherein the regulator comprises a housing and the sensor system comprises a pressure sensor, a proximity sensor a position sensor, a motion sensor, a flow sensor, a temperature sensor or a gas sensor within the housing.

9. The system of claim 7 wherein the regulator comprises a valve assembly comprising an inlet for connection to a source of breathing gas, an outlet for connection to the facepiece to provide breathing gas to a user, an actuating mechanism for controlling flow of breathing gas between the inlet and the outlet and a flexible elastomeric diaphragm in operative connection with the actuating mechanism, the diaphragm being in fluid connection with ambient environment on a first side thereof and in fluid connection with an interior of the facepiece on a second side thereof, the sensor system comprising a proximity sensor, a position sensor or a motion sensor in operative connection with a moving component of the actuating mechanism or the diaphragm of the regulator or a pressure sensor or a flow sensor in fluid connection with a volume of the regulator on the second side of the diaphragm.

10. The system of claim 9 wherein the microphone is attached to the regulator.

11. A pressure regulator for use in connection with a facepiece, comprising a valve assembly including an inlet for connection to a source of breathing gas, an outlet for connection to the facepiece to provide breathing gas to a user, an actuating mechanism for controlling flow of breathing gas between the inlet and the outlet, a flexible elastomeric diaphragm in operative connection with the actuating mechanism, the diaphragm being in fluid connection with ambient environment on a first side thereof and in fluid connection with an interior of the facepiece on a second side thereof, and a sensor system adapted to be placed in operative connection with a communication system comprising a voice transmission system, the sensor system providing a signal to control the voice transmission system based at least in part upon measurement of a variable other than sound, the variable other than sound being related to speech of a user of the facepiece.

12. The regulator of claim 11 wherein the variable is related to respiration of the user.

13. The regulator of claim 12 wherein the sensor system provides a signal to control the voice transmission system at least in part on the basis of a stage or respiration.

14. The regulator of claim 13 wherein the voice transmission system comprises a microphone, and the control system controls output from the voice transmission system during at least inhalation to decrease noise associated with inhalation.

15. The regulator of claim 14 wherein the microphone is attached to the regulator.

16. The regulator of claim 13 wherein the sensor system detects inhalation by the user.

17. The regulator of claim 13 wherein the sensor system comprises a proximity sensor, a position sensor or a motion sensor in operative connection with a moving component of the actuating mechanism or the diaphragm of the regulator or a pressure sensor or a flow sensor in fluid connection with a volume of the regulator on the second side of the diaphragm.

18. A facepiece system for use in a respiration system, comprising a facepiece and a pressure regulator in fluid connection with the facepiece, the pressure regulator comprising a valve assembly including an inlet for connection to a source of breathing gas, an outlet for connection to the facepiece to provide breathing gas to a user, an actuating mechanism for controlling flow of breathing gas between the inlet and the outlet and a flexible elastomeric diaphragm in operative connection with the actuating mechanism, the diaphragm being in fluid connection with ambient environment on a first side thereof and in fluid connection with an interior of the facepiece on a second side thereof, and a sensor system adapted to be placed in operative connection with a voice transmission system of a communication system, the sensor system providing a signal to control the voice transmission system based at least in part upon measurement of a variable other than sound, the variable other than sound being related to speech of a user of the facepiece.

19. A method of controlling voice transmission of a user of a respiration system, comprising: controlling voice transmission based at least in part upon measurement of a variable other than sound, the variable being related to speech of a user of the facepiece.

20. The method of claim 19 wherein the variable is related to respiration of the user and controlling voice transmission comprises controlling output from a voice transmission system at least in part on the basis of a stage of respiration of the user.
